(19) United States
(12) Patent Application Publication
(10) Pub. No.: US 2006/0246181 A1
(43) Pub. Date: Nov. 2, 2006

(54) Pre-dough concetrate for baked products totally- or partly- risen with yeast

(75) Inventors: Rene Burgermeister, Stettfurt (CH); Bruno Zehnder, Wilen (CH); Meiert Johan Grootes, Hagendorn (CH)

Correspondence Address: JORDAN AND HAMBURG LLP, 122 EAST 42ND STREET, SUITE 4000, NEW YORK, NY, 10168, US

(73) Assignee: Panadoro Group AG, Zug (CH)

(21) Appl. No.: 10/566,086

(22) PCT Filed: Jul. 29, 2004
(86) PCT No.: PCT/CH04/00476

§ 371 Date: Apr. 20, 2006

(30) Foreign Application Priority Data
Jul. 29, 2003 (CH) 131/03

(51) Int. Cl. A21D 13/00

(52) U.S. Cl. 426/94

(57) ABSTRACT

A pre-dough concentrate for the production of baked products, a method for production of a pre-dough concentrate and the use of such a pre-dough concentrate for the production of baked products and the baked products produced from such a pre-dough concentrate are disclosed. The need for a suitable alternative for baked products and also for pre-dough arises for various reasons. Said pre-dough concentrate is based on a thermally-modified flour or parts thereof, made up with yeast and water. The pre-dough concentrate is a replacement product for pre-dough with similar, the same or improved functional properties, depending on the criterion, such as a good pre-dough from wheat flour, type 720 flour and fine flour. The pre-dough concentrate is characterized in having a bioactivity significantly higher than commercially available baking materials.

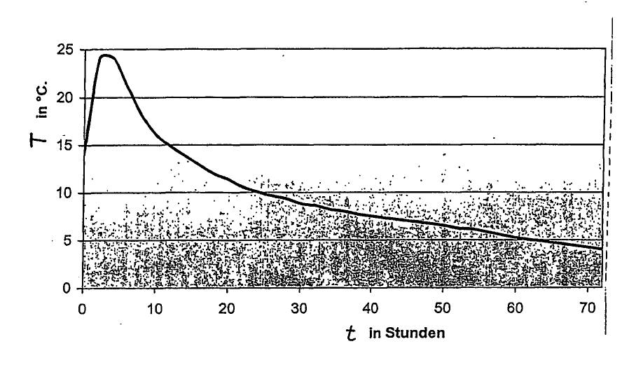

The present invention relates to a pre-dough concentrate for the production of baked products totally or partly risen with yeast according to the preamble of claim 1, a method for production of a pre-dough concentrate according to the preamble of claim 13 and the use of such a pre-dough concentrate for the production of baked products according to the pre-amble of claim 20 and the baked products produced from such a pre-dough concentrate according to the preamble of claim 19.

Pre-doughs which account for between 20-40% of the total quantity of dough in bread production have the following general functions:
formation of lactic and acetic acids for gluten stabilisation, for improving the fresh keeping of the bread and for protection from filamentous bacillus;
yeast multiplication;
better incorporation of water by means of pre-swelling and decomposition of gluten-forming proteins;
formation of precursors of bread flavourings by the enzymatic breakdown of protein, fat and starch.

The known lever or pre-dough methods are divided into two groups. The method using added baking yeast during production of the pre-dough is the most widely used today. In the alternative method, e.g. during production of the madre/pre-dough, the direct addition of baking yeast is dispensed with and the pre-dough is seeded by means of a madre (mother dough). The yeasts in the madre have been cultivated for several hours from wild yeasts present in the indoor air. Both methods are not only very time-consuming but as a consequence of the space required and the infrastructure for the large volumes of pre-dough, are also very cost-intensive.

For these organisational and financial reasons, since the beginning of the seventies, most bakeries have successively converted to direct dough guidance, i.e. dough production using baking agents and without pre-dough. The baking agents required for this purpose consisted mostly of malt products, in many cases supplemented with acids (e.g. citric acid, lactic acid), calcium phosphates, lecithin (E322) as emulsifier and ascorbic acid (E300). The baking agents today still largely correspond to this composition. Instead of malt products and lecithin, a combination of biotechnologically produced enzymes, swelling agents such as pre-gelatinised wheat flour or guar kernel flour (E412) and/or emulsifiers such as diacetyl tartaric acid esters (E472e), distilled monoglycerides (E471) etc. is used.

The many scandals in the food industry have had the result that the consumer is increasingly searching for products close to nature. The growth in turnover in organic products over the last few years confirms this development. Particularly in the case of products required daily such as bread, for example, there is thus an increasing desire to produce this without baking agents. Not only the formation of dust during application (allergies) but also the many undesirable additives, which are frequently evenly perceived as damaging to health, are resulting in an increasing stronger rejection of these products.

There is thus a need for a suitable alternative both for baking agents and also for the pre-dough. It is therefore the object of the present invention to provide a composition for the production of bakery products which does not have the aforesaid disadvantages of conventional pre-doughs and baking agents. In addition, advantageous uses of the composition for production of baked products should be provided. Furthermore, the pre-dough concentrate according to the invention should have a low dose (at most 10% wt. % of the quantity of flour in the main dough), it should be easy to handle and not least it should have adequate keeping qualities. Also the acceptance of the pre-dough concentrate should be improved by very good processing properties (short dough maturing time, dry, plastic doughs), an improvement in the baking properties (faster oven operation with good loosening of crumb and crust, nice crust colour) and an improvement in the sensory properties (smell, taste, chewing sensation). Finally, a wide field of application, i.e. in various recipes using different types of flour and qualities of flour, is strived for.

Comprehensive experiments have shown that the most important functional traits of the pre-dough concentrate according to the invention such as baking properties, smell and taste of baked products or fresh-keeping of baked products etc. are determined in particular by (1) the main dry raw material and (2) the production process (fermentation). These will be discussed in overview hereinafter as well as (3) some important characteristics of the pre-dough concentrate, before the composition of the pre-dough concentrate according to the invention and the production steps are presented in detail.

(1) The pre-dough concentrate according to the invention is based on thermally modified ground products of cereals, made up with yeast and water. The pre-dough concentrate is a highly nutritious replacement product for the pre-dough/lever, having similar, the same or better functional properties than a good pre-dough from the respective cereal products according to the criterion. In addition, the pre-dough concentrate differs significantly from the baking agents available on the market by the bioactivity which is present.

(2) The following characteristics apply with regard to the production process, especially the fermentation and subsequent storage: the freshly produced pre-dough concentrate begins; to ferment immediately and the temperature is increased rapidly by the fermentation heat to 26° C. to 36° C. In order to avoid overheating (especially above 32° C.), which can result among other things in undesirable development of acid and killing of the yeast, cooling must be started as rapidly as possible, preferably by circulating cold air at around 0° C. to 2° C. In this way, a product temperature of about 0 to 4° C. is achieved within three days. This temperature is sufficient to reduce the fermentation process to a minimum. Since the fermentation continues to a reduced extent, the product should be stored cooled, preferably with cold air circulating in a temperature range between 0° C. and 6° C. The pre-dough concentrate is supplied to the consumer with an optimal degree of fermentation (a minimum 4 days old) and at a temperature of below 6° C., packed in disposable or returnable packaging with a plastic insert or in a container. The shelf life when stored correctly is up to 6 months.

(3) The new pre-dough concentrate is preferably supplied as a dough-like paste for bakeries with manual weighing or as a liquid product/suspension for bakeries with automatic metering. Depending on the content of fibrous substances, pre-swelling of the starch, yeast fraction and desired viscosity, the water fraction in the pre-dough concentrate can be adjusted from a lower limit of about 30 wt. % for a dough-like paste as far as an upper limit of about 90 wt. % for a liquid product. Both products are also supplied with a fully integrated yeast fraction, that is as so-called all-in-one products.

In terms of quantity the pre-dough concentrate according to the invention accounts for between 3-8 wt. % of the quantity of flour in the main dough or 1.5-5 wt. % of the quantity of main dough.

The specific weight of the pre-dough concentrate in the form of the pre-dough paste lies between 850 and 1000 g/litre, preferably 900 and 950. Depending on the basic recipe (ascorbic acid content) and type and duration of the fermentation, the pH of the pre-dough concentrate is between 4.0 and 6.5, preferably 4.7 to 5.7. The fraction of active yeast cells is 0.1-1.0×10⁶, preferably 0.8×10⁶ per gram of pre-dough concentrate.

The freezing point for the dough-like paste-like pre-dough concentrate is about −5° C. and about −3° C. for the liquid product.

In general, the product can be used for baked products totally or partly risen with yeast. In the case of baked products having a high rye content (>60% rye flour fraction), in addition to the pre-dough concentrate, an acidifier should also be added to ensure bakeability.

In general, the existing basic recipes can be retained when using the new pre-dough concentrate in all baked products risen with yeast. However, the following should be corrected:
the baking agent should be completely replaced by the quantity of pre-dough concentrate specified according to the recommendation.
If the baking agent contains other ingredients dependent on the recipe such as milk powder, fats, sugar etc. in addition to the baking-promoting substances, these should be additionally added in the necessary quantity.
The quantity of yeast should be reduced by about 10% if the dough guidance time is short and by about 30% for long dough guidance if the other process parameters are not changed.
The dough strength should be adapted by increasing the bulk quantity of water. If the baking agent contains swelling ingredients such as guar or pre-gelatinised flours, this is not generally required.

The pre-dough concentrate according to the invention is suitable for all known dough guidance and baking systems such as the fermentation delay and fermentation interruption methods, the PATT system and all pre-baking, cooling and deep freezing systems.

In addition to the desired properties which have already been mentioned above, the pre-dough concentrate according to the invention is distinguished by an acceleration of dough development, optimisation of the processing properties of the dough and promotion of the sensory properties of the baked products. This is particularly shown to advantage by the better and stronger smell and taste of the baked products and by the more pleasant consumption properties such as a shorter, more tender crust and crumb.

The composition of the pre-dough concentrate according to the invention and the production process is now described in detail hereinafter.

Pre-Dough Concentrate

A. Main Dry Raw Material

The main dry raw material comprises a ground product of cereal, i.e. mechanically pulverised or mechanically modified cereal products (cereals). Hereinafter, pearl-barley, grits, flakes, crushed grain, semolina, mist, flour, gluten or pre-gelatinised flour are understood thereby.

The following starting raw materials (types of cereal) are suitable for use in the pre-dough concentrate according to the invention.
a. Indehiscent fruits (caryopses) of grasses (graminae) such as wheat (soft and hard wheat), spelt, rye, maize, rice, barley, oats, sorghum, millet and triticale;
b. Starch-containing cereals such as buckwheat, amaranth and quinoa.

As will be described, the ground product must be thermally treated so that it can be used as the main dry raw material for the pre-dough concentrate according to the invention.

The ground product is preferably a cereal flour having a majority particle size of less than 180 μm. Experiments have shown that ground products such as wheat, barley, triticale, rye, spelt, emmer, kamut, unripe spelt grain, one-grained spelt, oats and barley flour and mixtures thereof give the best results when used in the pre-dough concentrate according to the invention. Other ground products, such as for example, maize, rice and sorghum can also be used in mixtures with other cereal flours. It is preferable to use whole-grain flours or ground products which naturally have a high content of fat and fibrous substances. Also malted cereal especially oats and wheat which have undergone a thermal modification are very well suited for the production of the pre-dough concentrate.

In order to be able to be used for production of the pre-dough concentrate according to the invention, the main dry raw material must be able to absorb its own dry weight of water, at least once, preferably many times. The improvement in the water absorption of the ground product for use in the pre-dough concentrate according to the invention is achieved by thermally pre-treating or modifying it.

The thermal treatment takes place preferably between 120 and 170° C., especially preferably around 150-160° C. Higher temperatures do not result in a further improvement in the functional properties, especially the water absorption, but only organoleptic modifications take place, that is roasting smells are produced. The duration of the treatment is dependent on the system and is between one second and several minutes.

The following thermal modification methods have proved to be advantageous for the treatment of the ground products used:

Hydrothermal method: One method for modifying ground cereal products is the hydrothermal treatment. A machine suitable for this is the so-called microniser (infrared treatment) wherein the material is briefly treated using infrared emitters (heat generators) in continuous mode. This has the result that the water vapour produced inside the ground cereal products loosens the structure (internal breakdown) and partly sticks together the starch. During preparation of the dough the water can thus be absorbed rapidly. This method is very widely used and is built into various combinations of appliance parts. The flour heat treatment (FHT) system developed by the mill construction company Bühler belongs to this group.

Pressure thermal method (RMS). In this method a steriliser is filled with the ground cereal product via a valve which is located in an upwardly directed position during the filling process. After the filling process the system is closed and steam is supplied directly to the ground product until a pressure of 3 bar abs. is reached. The steriliser is started and remains in rotation during the entire sterilisation process (20 min). During the filling process and the sterilisation, the rotating jacket is indirectly heated at a vapour pressure of 3.5 bar abs. The system rotates during the entire sterilisation time to ensure that all the particles are subjected to complete sterilisation. After the sterilisation process, the excess steam is released from the product space. A vacuum system then starts to operate in order to remove excess residual steam. A reduction in the temperature of the ground product (to about 30° C.) can also achieved by the vacuum system depending on the residual moisture. The emptying process then takes place through the drain valve located at the side of the steriliser, the ground product steriliser continuing to rotate.

Mechanical thermal method by means of extrusion. Another method which has proved successful is the extrusion of cereal products. This method allows ground cereal products to be treated rapidly and therefore gently on the nutrients.

The ground product can be processed by this method, for example, using a twin-screw extruder from Bühler. In an advantageous embodiment the shaft length is 1.50 m and the diameter is 93 mm. In the first quarter of the extruder, about 15-16% of the water is added. The ground cereal product is processed thermally (extrusion temperature about 150° C.) and mechanically (the maximum screw speed is 450 revolutions per minute) in the extruder. Since the extruder is preferably only operated at about 50-60% of the maximum revolutions, the mechanical processing can be described as rather gentle. A nozzle plate having 24 holes each having a diameter of 6 mm is attached at the end of the extruder. Since the extruder is operated at low revolutions and the holes in the nozzle plate are rather large, a comparatively low pressure of 5 bar maximum builds up in the extruder. The residence time in the extruder with the above parameters is about 5 sec. The extrudate leaves the extruder in a strand in a pasty consistency. A type of cube is formed by cutting the extrudate strands directly after the nozzle plate. These are extracted, dried at 140° C. and finely ground by means of a hammer mill.

Mechanical-thermal methods by means of rotor (CP impact mill and CSM sifter mill). Both grinding systems are very similar. In the impact mill the rotors are arranged horizontally and in the sifter mill they are arranged vertically. The grinding/pulverising takes place between the rotor and the grinding track, whereby the beaters of the grinding disk grasp the product particles and hurl them against the grinding track. The pressure produced in this case and the mechanical heating is sufficient in most cases to obtain satisfactory modification of the ground product. Experiments have confirmed that a ground cereal product modified by this method can be used in the pre-dough concentrate according to the invention.

Mechanical-thermal, pressure-thermal or hydrothermal (hot air heating) treatments have proved advantageous for heating the ground cereal products used. In experiments carried out so far it has been shown that the type of treatment has little to no measurable influence on the suitability of the main dry raw materials for the production of the pre-dough concentrate according to the invention. However, it is important that the ground cereal product to be treated has a moisture content of 10-19 wt. %, preferably 13 wt. % before thermal modification.

The aim of the thermal modification of the main dry raw material is that depending on the starch content, 30% to 100% of the starch present in the cereal is present in pre-swollen quality and that the gluten present is at least 60% denatured.

The pre-swollen starch grains have a larger surface area, therefore bind more liquid and can thus be better fermented. The gluten is a rubber-like elastic mass consisting predominantly of water-insoluble proteins such as glutenin and gliadin. As a result of the thermal treatment, the gluten completely or partly loses its capacity to form new disulphide bridges (S—S bonds) during addition of liquid, e.g. during production of the main dough. This so-called binding or adhesive function is one of the most important properties in normal production of the main dough. During production of the pre-dough concentrate which must have a short structure, this function is therefore only desirable to a limited extent.

B. Remaining Dry Raw Materials

The remaining added dry material is used on the one hand for forming the structure of the pre-dough concentrate with a preferably shorter structure, on the other hand these play a crucial role during production of the baked products, for example, cooking stability, dough development etc. They should be selected complementarily according to the quality and property of the main raw material. The most important remaining dry materials are:
wheat flours
malt flours
gluten

Thus, for example, when using fibre-rich ground cereal products (more than 15 weight percent fibre) as the main dry raw material, malt flour, gluten and possibly wheat flour are required to produce the pre-dough concentrate.

If, to give another example, finely ground whole-grain flour (about 180 μm) that has been thermally modified at 160° C. is used, a perfect pre-dough concentrate quality is achieved without adding further dry raw material. When using malted and subsequently extruded barley, very good results are also achieved without adding further dry raw material.

C. Wet Raw Materials

The wet raw materials are used for fermentation and formation of the structure in the pre-dough concentrate and comprise:
yeast, milk and yeast blend or wild cultivated yeast (natural raising)
water

Depending on the water absorption capacity of the dry substances, it is necessary to add about 40-50 wt. % of wet raw material. In the case of liquid pre-dough concentrates, the addition of wet raw material must be adapted according to the desired final viscosity. If the fraction of wet raw materials is too high, there is a risk of segregation or sedimentation during storage.

The quantity of yeast in the pre-dough concentrate depends on the desired final application. For the pure fermentation process of the pre-dough concentrate, it is sufficient to add 3 wt. % of the total weight of baking yeast. If more yeast is used, this causes a reduction in the quantity of yeast in the main dough. From a yeast fraction of about 15% in the pre-dough concentrate, it is no longer necessary to add yeast in the main dough during long dough guidance (about 2½ hours).

D. Functional Substances

Depending on the desired quality of the pre-dough concentrate, the following functional substances are advantageous or necessary:
ascorbic acid or fruit juice extracts having a natural ascorbic acid content (Vitamin C)
bee honey
enzymes (amylase, protease, pentosanase)

Ascorbic acid is used as an antioxidant in the pre-dough concentrate and later as a flour treatment agent during production of the main dough. As an alternative, a fruit juice concentrate having a high ascorbic acid content (Vitamin C) can be used, for example, acerola juice concentrate. If wheat flours treated with ascorbic acid (3-8 ppm ascorbic acid) are used to produce the main dough, the addition of ascorbic acid in the pre-dough concentrate is reduced or superfluous accordingly.

Enzymatic processes are very important during the production of pre-dough concentrate according to the invention. Native enzymes are contained in the following raw materials:
in the main dry raw material;
in enzymatically active malt flours
in the yeast
in bee honey.

In addition to many sugars, bee honey also contains enzymes such as amylases, proteases and glucoseoxidases. Additions of further enzymes are only necessary if there are insufficient quantities of native enzymes.

E. Ash Content

The ash content varies depending on the degree of fineness of the type of cereal used. Flours having a high bran content contain substantially more minerals. The possible maximum ash content of a very dark pre-dough concentrate—pre-dough is about 2%. In a very light version the minimum is about 0.3%.

Method for Production of the Pre-Dough Concentrate

A. General

Most fermentation processes are carried out using liquid nutrient broths. Known example in the food industry are the production of yoghurt, beer, wine, lactic acid and many food flavourings. However, the food industry also uses so-called solid-state fermentation or solid substrate fermentation (SSF). In SSF moist solid nutrients are mostly used instead of a liquid nutrient broth. Known examples are the production of French cheese, such as Roquefort and Brie, for example, the production of fermented sausages and the production of Asiatic fermented foodstuffs such as tempe and soy sauce. In Asia, SSF has been used for more than 2000 years for the fermentation of foodstuffs.

Substrates used in SSF are cereal or beans, for example. Most SSFs use moulds because these are excellent producers of extracellular hydrolases which break up the biopolymers present in solid substances. They are capable of colonising at the solid particles and penetrating, i.e. they need not be homogeneously mixed by the substrate to allow efficient use of the substrate. However, some SSF also use yeast (e.g. Saccheromyces cerevisiae) or bacteria, e.g. lactobaccilli in sausages, bacillus ssp in Japanese natto and Aceto bacter ssp in Chinese vinegar.

Yeast is used exclusively for the pre-dough concentrate according to the invention. The term “yeasts” is generally understood as all fungi having yeast-like growth. This generally comprises single cells which multiply by budding or cleavage. The egg-shaped cells have a length of 8-12 μm and a diameter of 4-8 μm. In the case of baking yeast these strains differ only slightly; they belong without exception to said species “Saccharomyces cerevisiae”. These yeasts are distinguished by high raising power and few gluten-destroying enzymes.

Traditional baking yeast consists of 99.5% pure cellular substance. This comprises the cell wall which encloses the cell fluid (cytoplasm) and the cell nucleus. Located in the cell nucleus are the chromosomes which determine the strain and therefore all the properties of the baking yeast. The “colour” of the baking yeast is influenced by the molasses solution in which the baking yeast is cultivated. However the quality features which are far more crucial for the user are in particular the raising power and the keeping qualities.

In the case of SSF, temperature control is very much more difficult than in a liquid nutrient broth because of a layer of solid parts with gas—e.g. CO₂—filled pores which is a very poor heat conductor. It is very difficult and inefficient to cool the surfaces in a bed of such solid substances. This means that undesirable increases in temperature develop more rapidly in the thicker layers of solid nutrients.

B. Mixing and Fermentation Using Compressed Yeast or Yeast-Milk Blend

The pre-dough concentrate is fermented using normal compressed yeast, yeast-milk blend, the filtrate obtained with compressed yeast or a mixture thereof. No synthetic acids such as, for example, acetic acid, lactic acid or starter cultures are used.

The pre-dough concentrate according to the invention preferably comprises:
thermally modified ground cereal products (preferably 140° C.-160° C.; particle size 150-210 μm, preferably 180 μm), preferably a cereal flour having a high fibre and fat content as main dry raw substance;
yeast, where the yeast comprises compressed yeast (about 28% dry substance TS) and/or yeast-milk blend (20% TS) and also the filtrate produced during production of the compressed yeast;
water.

According to the quality, properties of the main dry raw material and application, other raw materials are added, preferably
malted cereal products, preferably malt flour
ascorbic acid
enzymes [see above]

C. Production of paste and/or liquid product: the dry substances are weighed together and mixed. The wet raw materials are then added at an initial temperature of about 3° C. and blended with the dry substances to form a dough-like paste and briefly kneaded.

The freshly produced pre-dough concentrate having an initial temperature of about 12° C. to 20° C. immediately begins to ferment and the temperature is rapidly increased by the fermentation heat to 26° C. to 36° C. In order to prevent overheating (especially above 32° C.) which among other things can result in undesirable acid development and killing of the yeast, the cooling must be initiated as rapidly as possible which is preferably accomplished by circulating cold air at 0 to 2° C. In this way, a paste temperature of about 0 to 4° C. is achieved in about 3 days. The temperature is sufficient to reduce the fermentation process to a minimum.

In the batch method agitation or processing of the pre-dough concentrate must be omitted as far as possible during the fermentation process since the CO₂ gases formed are released and the fermentation and thus the heating is accelerated again. In the continuous method the processing should be carried out as gently as possible or in a protective atmosphere.

The pre-dough concentrate according to the invention in the form of a dough-like paste is then portioned into plastic lattice containers covered with plastic film (measuring 40×60 cm) and cooled in a location with strongly circulating cold air at about 0° C. to 6° C.

TABLE
Temperature behaviour of the pre-dough concentrate during fermentation at a cooling
air temperature of 2° C.

| | Hours | | | | | | | | | | | |
|---|---|---|---|---|---|---|---|---|---|---|---|---|
| | 0 | 2 | 4 | 6 | 8 | 10 | 12 | 14 | 16 | 18 | 20 | 22 |
| T (° C.) | 14.0 | 24.0 | 24.0 | 21.0 | 18.0 | 16.0 | 14.8 | 13.8 | 12.8 | 11.9 | 11.3 | 10.5 |
| | Hours | | | | | | | | | | | |
| | 24 | 26 | 28 | 30 | 32 | 34 | 36 | 38 | 40 | 42 | 44 | 46 |
| T (° C.) | 10.0 | 9.6 | 9.3 | 8.8 | 8.6 | 8.2 | 8.0 | 7.7 | 7.5 | 7.3 | 7.1 | 6.9 |
| | Hours | | | | | | | | | | | |
| | 48 | 50 | 52 | 54 | 56 | 58 | 60 | 62 | 64 | 66 | 68 | 70 |
| T (° C.) | 6.7 | 6.5 | 6.2 | 6.1 | 5.8 | 5.5 | 5.2 | 5.0 | 4.8 | 4.6 | 4.4 | 4.2 |

The figure shows the temperature behaviour of the pre-dough concentrate during fermentation at a cooling air temperature of 2° C. T is the temperature of the pre-dough and t is the fermentation time at 2° ⁺C. (cooling temperature).

If iced water is added to the dough-like paste after fermentation for 2 days whilst stirring, a pumpable liquid product (suspension) is produced which is poured into containers and stored in a cool place.

The optimal process conditions for the fermentation of the pre-dough concentrate are as follows:
the product must not be heated above about 32° C. during the fermentation process.
The main fermentation process must be carried out as far as possible at low temperatures (about 6° C.) and predominantly in the anaerobic region.
In order to maintain the strictest possible anaerobic conditions, the product must not be processed during and after the fermentation process.
The main fermentation process should be reduced to a minimum after about 3 days by cooling to about 2-4° C.

Reasons:
a) The yeast fermentation process is a biological process in which predominantly starch and sugars are broken down to give acids, CO₂ and alcohol. In addition, a large amount of heat is produced in this process. If this heat is insufficiently removed because of too little cooling, the product temperature increases whereby the classical yeast activity becomes lower. For this the process conditions for the so-called non-definable accompanying flora of the yeast which consists of about 60 to 150 different organisms are better. This accompanying flora is known for the excessive production of acids such as acetic, lactic or propionic acid and other undesirable degradation products.
b) A fermentation process of about 3 days in the predominantly anaerobic range (Table 1, hours 4-72) promotes the formation of desired flavour precursors and flavourings.
c) The fermentation process must be largely minimised after about 3 days by cooling to about 2° C.-4° C. Subsequent heating to temperatures above about 6° C.-8° C. is then no longer sufficient to start the main fermentation process again. As a consequence of the high insulation value of the pre-dough concentration mass it is otherwise difficult to quickly raise the product temperature.
d) In order not to disturb the predominantly anaerobic fermentation process, the product must not be processed (kneaded, agitated, transferred etc.) during the fermentation and cooling process or at most in a protective atmosphere (nitrogen or similar). Otherwise the CO₂ formed will be released and an aerobic fermentation reaction will take place again with new nitrogen.
e) The CO₂ formed in the product reduces the yeast activity and is used together with the alcohol formed to preserve the product. A shelf life of several weeks is achieved using the predetermined storage at <6° C.

As has been mentioned above the crucial feature of the pre-dough concentrate according to the invention is the bio or yeast activity. The yeast activity can be determined using the living yeast cells from the pre-dough concentrate. In preferred pre-dough concentrate products (comprising about 5% yeast-milk blend to total weight), the fraction of active yeast cells is about 0.8×10⁶ per gram of pre-dough concentrate. In the cooled and anaerobic range the number of yeast cells in the pre-dough concentrate remains almost constant during storage.

In addition to the yeast cells, the baking yeast possesses a so-called “non-definable accompanying flora” of microorganisms. These are deliberately kept low by the yeast manufacturers in order not to disturb the alcoholic fermentation process of the yeast and to keep the yeast quality high. Among other things, these are bacteria which can also produce acetic, lactic and butyric acid and can contribute to improving the taste or deterioration of the baked products. Some undesirable bacteria die as a result of the metabolic products of the yeast such as CO₂ and alcohol.

In a preferred form of the pre-dough concentrate according to the invention, a natural protection from oxidation is achieved by the addition of ascorbic acid or ascorbic-acid-containing fruit extracts specified above which ensures that the fermented cooled paste can be kept for many months. At the same time, ascorbic acid stabilises and protects the gluten during guidance of the main dough during production of the baked products.

### EXAMPLES

a) pasty pre-dough concentrate for yeast-risen baked products of “dark or light” untreated baking flours

| Pre-dough concentrate “dark/light” | Preferred | Minimum | Maximum |
|---|---|---|---|
| dough | % | % | % |
| Thermally modified ground cereal | 38.7 | 10 | 50 |
| products | | | |
| Diastase-malt flour | 6 | 0 | 20 |
| Gluten | 5 | 0 | 10 |
| Ascorbic acid | 9.2 | 0 | 1 |
| Enzyme | 0.1 | 0 | 1 |
| Yeast-milk blend | 10 | 2 | 50 |
| Yeast filtrate/water | 40 | 0 | 50 |
| Total | 100 | | |

b) Pre-dough concentrate in suspension for yeast-risen baked products of “dark or light” untreated baking flours

| Pre-dough concentrate “dark/light” | Preferred | Minimum | Maximum |
|---|---|---|---|
| dough | % | % | % |
| Thermally modified ground cereal | 22 | 6 | 30 |
| products | | | |
| Diastase-malt flour | 3.7 | 0 | 15 |
| Gluten | 2.2 | 0 | 8 |
| Ascorbic acid | 0.1 | 0 | 0.5 |
| Enzyme | 0.05 | 0 | 0.5 |
| Yeast-milk blend | 6 | 1 | 50 |
| Yeast filtrate/water | 66 | 0 | 90 |
| Total | 100 | | |

For the examples the yeast-milk blend preferably has a TS content of 18-22%, especially preferably of 20%.

c) Pasty pre-dough concentrate with natural yeast for yeast-risen baked products of “dark or light” untreated baking flours

| Pre-dough concentrate “dark/light” | Preferred | Minimum | Maximum |
|---|---|---|---|
| dough | % | % | % |
| Thermally modified ground cereal | 34 | 10 | 50 |
| products | | | |
| Diastase-malt flour | 6 | 0 | 20 |
| Gluten | 4.7 | 0 | 10 |
| Ascorbic acid | 0.2 | 0 | 1 |
| Enzyme | 0.1 | 0 | 1 |
| Madre (mother dough) | 30 | 5 | 50 |
| Water | 25 | 0 | 45 |
| Total | 100 | | |

Madre or mother dough consists of a risable culture of cereal flour, water and wild yeasts cultivated over several stages and days, which must be continuously multiplied according to use. Since a madre contains substantially less active yeast cells than the baking yeast, the dosage is correspondingly high. Madre can either be self-cultivated—relevant methods are described in the literature—or bought in reproducible quality. The production of the pre-dough concentrate using madre corresponds to the production using yeast.

Processing of the Pre-Dough Concentrate

The new pre-dough concentrate has significant advantages during processing in baked product operations since it can be added directly to the main dough during preparation instead of a conventional pre-dough. In the experiments it was ascertained that the necessary quantity of yeast lies below that which would be required during a conventional direct dough guidance using baking agents. In addition, the dough could be processed significantly more rapidly than when using baking agents and pre-dough, resulting in a saving of time in the production. Also the bulk quantity of water could be increased, i.e. a higher dough yield is achieved. The new pre-dough concentrate has major advantages here particularly compared with the direct competitor pre-dough because a significantly lower dough yield is known to be achieved with pre-dough. The dough yield of the new pre-dough concentrate is similar to that with good baking agents.

As has already been mentioned, the new pre-dough concentrate can also be supplied as an “all-in-one” product, that is it already contains the quantity of yeast required to produce the final dough so that no more yeast need be added to the final dough. In the bakery only flour, water and salt need to be added to the “all-in-one” product.

Other Areas of Application

Since it is known that rye flour contains no gluten, it must be made bakeable by acidification. This can conventionally be accomplished by means of multistage guidance or by addition of acid or strongly acid-containing baking agents. The new pre-dough concentrate is not an acidifier and thus is only suitable for rye bread with the addition of known acidifiers.

The products having a similar function which have already been known for a long time all originate from rye or rye mixed bread production.

1. Pre-dough concentrate comprising:
thermally modified ground cereal products;
yeast;
water.

2. The pre-dough concentrate according to claim 1, wherein the gluten of the thermally modified ground products is at least 60% denatured.

3. The pre-dough concentrate according to claim 1 or claim 2, wherein the thermally modified ground products account for 6 to 50 wt. %, preferably 22 to 39 wt. % of the pre-dough concentrate.

4. The pre-dough concentrate according to claims 1 or 2, wherein 30 to 100% of the starch present in the thermally modified ground product is present in pre-swollen quality.

5. The pre-dough concentrate according to claims 1 or 2, wherein the thermally modified ground products have passed through a hydrothermal, pressure-thermal or thermal-mechanical treatment.

6. The pre-dough concentrate according to claim 5, wherein the thermal mechanical treatment is carried out by means of extruders or by means of rotors.

7. The pre-dough concentrate according to claims 1 or 2, wherein the thermally modified ground products are treated at temperatures of 120 to 170° C., preferably at 150 to 160° C.

8. The pre-dough concentrate according to claims 1 or 2, wherein the thermally modified ground products have particle sizes of 150 to 210 μm, preferably of 180 μm.

9. The pre-dough concentrate according to claims 1 or 2, wherein the thermally modified ground products are cereal flours.

10. The pre-dough concentrate according to claims 1 or 2, comprising ascorbic acid.

11. The pre-dough concentrate according to claims 1 or 2, comprising malt flour, gluten, wheat gluten and/or amylase enzyme complex.

12. The pre-dough concentrate according to claims 1 or 2, wherein the yeast is compressed yeast (about 28% dry substance (TS)) or milk and yeast blend (20% TS) or the filtrate produced during manufacture of compressed yeast or a mixture of the aforesaid.

13. The method for producing a pre-dough concentrate according to claims 1 or 2, wherein at least one thermally modified ground product, yeast and water is blended to form a thick-liquid to solid paste or a suspension.

14. The method for producing a pre-dough concentrate according to claim 13, wherein the yeast comprises a yeast from the following group or mixtures thereof: directly added compressed yeast, milk and yeast blend or wild cultivated yeast which is inoculated naturally from the ambient air.

15. The method according to claim 13, wherein the main fermentation is carried out in the anaerobic region at temperatures of 4 to 8° C., preferably at around 6° C.

16. The method according to claim 12, wherein the main fermentation is severely inhibited by cooling to 0° C. to 4° C., preferably to 2° C.

17. The method according to claim 13, wherein after blending it is allowable to heat the pre-dough concentrate to 25° C. up to a maximum of 32° C. and within 72 hours said pre-dough concentrate is cooled to a paste temperature of about 0° C. to 4° C., preferably 2° C.

18. The method for producing a pre-dough concentrate according to claim 13, wherein at least one thermally modified ground product, yeast and water is blended to a thick-liquid to solid paste and fermented in a solid state fermentation.

19. Baked products, preferably bread comprising flour, water, yeast and cooking salt, additionally comprising thermally modified ground products and is baked from a final dough comprising a pre-dough concentrated according to claims 1 or 2.

20. A method for producing baked goods, preferably bread, wherein a pre-dough concentrate according to to claims 1 or 2 is blended with flour, water and cooking salt to form a final dough and is processed in direct dough guidance.

21. The method according to claim 19, wherein a fraction of 1.5 to 5 wt. % of pre-dough concentrate according to claims 1 or 2 is processed to form a final dough using wheat flour.
